(19) United States
(12) Patent Application Publication
(10) Pub. No.: US 2023/0384449 A1
(43) Pub. Date: Nov. 30, 2023

(54) RANGING DEVICE

(71) Applicant: CANON KABUSHIKI KAISHA, Tokyo (JP)

(72) Inventor: SHOGO YAMASAKI, Kanagawa (JP)

(21) Appl. No.: 18/322,437

(22) Filed: May 23, 2023

(30) Foreign Application Priority Data
May 24, 2022 (JP) 2022-084360

(51) Int. Cl. G01S 17/14; G01S 7/4863; G01S 7/484; G01S 7/4865

(52) U.S. Cl. CPC G01S 17/14; G01S 7/4863; G01S 7/484; G01S 7/4865; G01S 17/931

(57) ABSTRACT

A ranging device includes a time counting circuit, a pulse generation circuit, first and second holding circuits, and a comparison circuit. The pulse generation circuit generates a signal including a pulse based on light. The first holding circuit sequentially performs an operation of holding a pulse count value based on the number of pulses in a count period. The second holding circuit holds N sets of identification information indicating one of count periods and a pulse count value corresponding to the identification information. The comparison circuit compares the pulse count value held in the first holding circuit with the N pulse count values held in the second holding circuit and performs an update process of holding, in the second holding circuit, identification information that specifies each of count periods whose rank of pulse count value is up to the N-th, and a pulse count value corresponding to the identification information.

### BACKGROUND OF THE INVENTION

### Field of the Invention

The present disclosure relates to a ranging device.

### Description of the Related Art

Japanese Patent Application Laid-Open No. 2020-186949 discloses a ranging device that measures a distance to an object based on a time difference between a light projecting timing and a light receiving timing. The ranging device of Japanese Patent Application Laid-Open No. 2020-186949 compares magnitude relationship between intensity of incident light and a reference level, and does not store a digital signal corresponding to incident light in a storage circuit when the intensity of incident light exceeds the reference level. Thus, in the ranging device of Japanese Patent Application Laid-Open No. 2020-186949, the storage capacity of the storage circuit is reduced.

However, in the method of determining whether or not to store a signal based on comparison between the amount of incident light and the reference level as described in Japanese Patent Application Laid-Open No. 2020-186949, if the relationship between the amount of incident light and the reference level is not appropriate, the accuracy of distance measurement may decrease. For example, when the amount of stored data exceeds the storage capacity of the memory, or when the amount of stored data is insufficient, the data for ranging is not appropriately secured, and the ranging accuracy may be degraded.

### SUMMARY OF THE INVENTION

It is an object of the present disclosure to provide a ranging device with reduced storage capacity while maintaining ranging accuracy.

According to a disclosure of the present specification, a ranging device includes a time counting circuit, a pulse generation circuit, a first holding circuit, a second holding circuit, and a comparison circuit. The time counting circuit is configured to count time over a period including a plurality of count periods. The pulse generation circuit is configured to generate a signal including a pulse based on light including reflected light from an object. The first holding circuit is configured to sequentially perform an operation of holding a pulse count value based on the number of pulses in a corresponding count period for each of the plurality of count periods. The second holding circuit is configured to hold N sets (N being an integer equal to or greater than 1) of identification information indicating one of the plurality of count periods and a pulse count value corresponding to the identification information. The comparison circuit is configured to compare the pulse count value held in the first holding circuit with the N pulse count values held in the second holding circuit and perform an update process of holding, in the second holding circuit, identification information that specifies each of count periods whose rank of magnitude of a pulse count value in descending order is up to the N-th, and a pulse count value corresponding to the identification information.

Further features of the disclosure will become apparent from the following description of exemplary embodiments with reference to the attached drawings.

### BRIEF DESCRIPTION OF THE DRAWINGS

FIG. 1 is a block diagram illustrating a schematic configuration example of a ranging device according to a first embodiment.

FIG. 2 is a diagram schematically illustrating an operation of the ranging device according to the first embodiment in one ranging period.

FIG. 3 is a flowchart illustrating the operation of the ranging device according to the first embodiment in one ranging period.

FIGS. 4A, 4B, 4C, 4D, 4E, 4F, 4G, and 4H are diagrams schematically illustrating information held in a ranking information holding circuit according to the first embodiment.

FIGS. 5A, 5B, 5C, 5D, 5E, 5F, 5G, and 5H are diagrams schematically illustrating information held in the ranking information holding circuit according to a second embodiment.

FIG. 6 is a block diagram illustrating a schematic configuration example of a ranging device according to a third embodiment.

FIG. 7 is a schematic diagram illustrating an overall configuration of a photoelectric conversion device according to a fourth embodiment.

FIG. 8 is a schematic block diagram illustrating a configuration example of a sensor substrate according to the fourth embodiment.

FIG. 9 is a schematic block diagram illustrating a configuration example of a circuit substrate according to the fourth embodiment.

FIG. 10 is a schematic block diagram illustrating a configuration example of one pixel of a photoelectric conversion circuit and a pixel signal processing circuit according to the fourth embodiment.

FIGS. 11A, 11B, and 11C are diagrams illustrating an operation of an avalanche photodiode according to the fourth embodiment.

FIG. 12 is a schematic diagram of a photodetection system according to a fifth embodiment.

FIGS. 13A and 13B are schematic diagrams of equipment according to a sixth embodiment.

### DESCRIPTION OF THE EMBODIMENTS

Preferred embodiments of the disclosure will now be described in detail in accordance with the accompanying drawings. In the drawings, the same or corresponding elements are denoted by the same reference numerals, and the description thereof may be omitted or simplified. In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or program that, when executed by the CPU, cause the CPU to perform operations corresponding to units or functions. In the hardware context, the term “unit” refers to a hardware element, a circuit, an assembly, a physical structure, a system, a module, or a subsystem. It may include mechanical, optical, or electrical components, or any combination of them. It may include active (e.g., transistors) or passive (e.g., capacitor) components. It may include semiconductor devices having a substrate and other layers of materials having various concentrations of conductivity. It may include a CPU or a programmable processor that can execute a program stored in a memory to perform specified functions. It may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials. Furthermore, depending on the context, the term “portion,” “part,” “device,” “switch,” or similar terms may refer to a circuit or a group of circuits. The circuit or group of circuits may include electronic, mechanical, or optical elements such as capacitors, diodes, transistors. For example, a switch is a circuit that turns on and turns off a connection. It can be implemented by a transistor circuit or similar electronic devices.

### First Embodiment

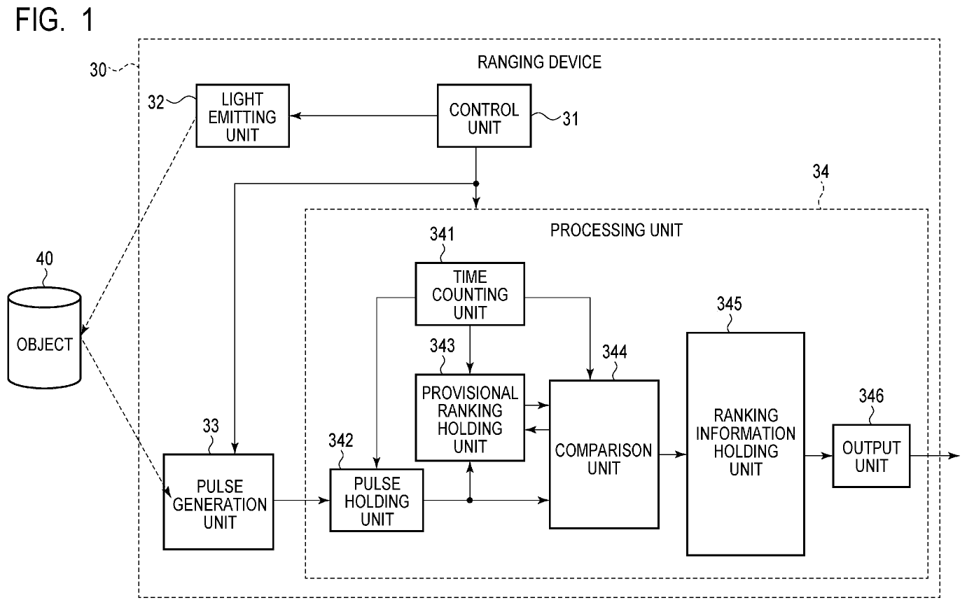

FIG. 1 is a block diagram illustrating a schematic configuration example of a ranging device 30 according to the present embodiment. The ranging device 30 includes a control unit or circuit 31, a light emitting unit or circuit 32, a pulse generation unit or circuit 33, and a processing unit or circuit 34. The ranging device 30 measures a distance to an object 40 by using a technique such as light detection and ranging (LiDAR). The ranging device 30 measures the distance from the ranging device 30 to the object 40 based on the time difference until the light emitted from the light emitting unit 32 is reflected by the object 40 and received by the pulse generation unit 33. The light received by the pulse generation circuit 33 includes ambient light such as sunlight in addition to the reflected light from the object 40. For this reason, the ranging device 30 measures incident light in each of a plurality of count periods, and performs ranging in which influence of ambient light is reduced by using a method of determining that reflected light is incident in a period in which the amount of light peaks. The ranging device 30 of the present embodiment may be, for example, a flash LiDAR that emits laser light to a predetermined ranging area including the object 40, and receives reflected light by a pixel array.

The control circuit 31 is a circuit that controls the circuits by outputting control signals indicating operation timings, operation conditions, and the like of the circuits to be controlled to the light emitting circuit 32, the pulse generation circuit 33, and the processing circuit 34.

The light emitting circuit 32 is a light source that emits light such as laser light to the outside of the ranging device 30. When the ranging device 30 is a flash LiDAR, the light emitting circuit 32 may be a surface light source such as a surface emitting laser.

The pulse generation circuit 33 converts the incident light into a pulsed signal including a pulse. The pulse generation circuit 33 is, for example, a photoelectric conversion device including an avalanche photodiode as a photoelectric conversion element. In this case, when one photon is incident on the avalanche photodiode and a charge is generated, one pulse is generated by avalanche multiplication. However, the pulse generation circuit 33 may be, for example, a photoelectric conversion element using another type of photodiode.

The processing circuit 34 includes a time counting unit or circuit 341, a pulse holding unit or circuit 342, a provisional ranking holding unit or circuit 343, a comparison unit or circuit 344, a ranking information holding unit or circuit 345, and an output unit or circuit 346. The processing circuit 34 is a signal processing circuit that performs signal processing on the pulsed signal output from the pulse generation circuit 33. The processing circuit 34 may include a counter for counting pulses, a processor for performing arithmetic processing of digital signals, a memory for storing digital signals, and the like. The memory may be, for example, a semiconductor memory such as a static random access memory (SRAM). The control circuit 31 controls the operation timing and the like of each circuit in the processing circuit 34.

The time counting circuit 341 performs time counting based on the control of the control circuit 31, and acquires an elapsed time from the time when counting is started as a digital signal. The control circuit 31 synchronously controls a timing at which the light emitting circuit 32 emits light and a timing at which the time counting circuit 341 starts time counting. Thus, the time counting circuit 341 can count the elapsed time from the light emission of the light emitting circuit 32. The time counting circuit 341 supplies a time count value to the pulse holding circuit 342, the provisional ranking holding circuit 343, and the comparison circuit 344. The time counting circuit 341 includes, for example, a circuit such as a ring oscillator and a counter, and counts clock pulses that vibrate at a high speed and at a constant period, thereby counting the time.

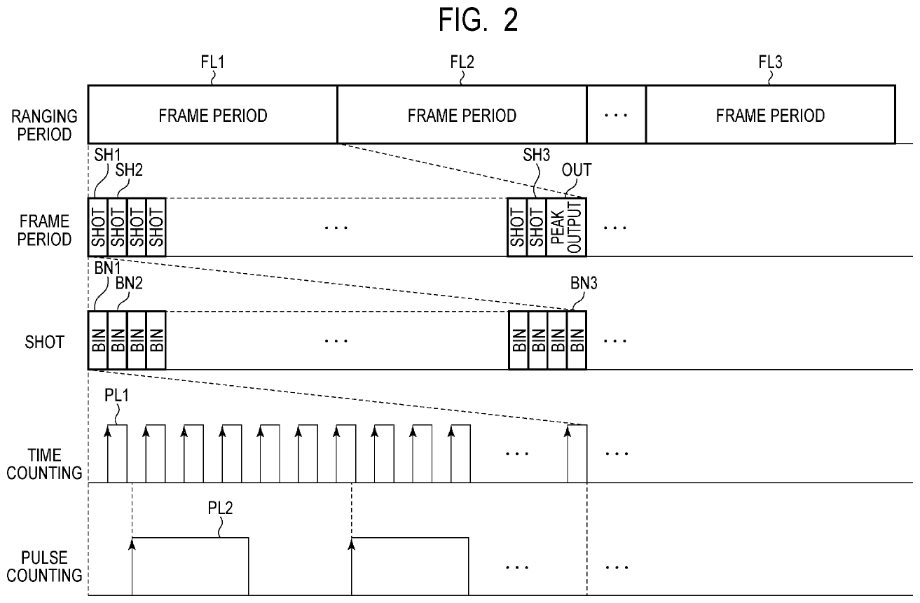

The light emitted from the light emitting circuit 32 is reflected by the object 40. The light including the reflected light from the object 40 is incident on the pulse generation circuit 33. The pulse generation circuit 33 converts the light into a pulsed signal and outputs the pulsed signal to the pulse holding circuit 342. The pulse holding circuit 342 has a function of counting pulses input from the pulse generation circuit 33 in each of a plurality of count periods of a predetermined period in which time counting is performed by the time counting circuit 341, and holding the pulse count value. The count period will be described later with reference to FIG. 2.

The pulse generation circuit 33 illustrated in FIG. 1 may include one or more photoelectric conversion elements. That is, the pulse generation circuit 33 corresponds to one or more pixels in the photoelectric conversion device. Further, the pulse holding circuit 342 may perform pixel binning processing in which a pulse count value obtained by integrating pulses based on incident light to the plurality of photoelectric conversion elements is held, thereby generating a signal in which the plurality of photoelectric conversion elements are regarded as the same pixel. Although the spatial resolution decreases by performing the pixel binning processing, the probability of detection of the reflected light from the object 40 increases, so that an effect of extending the distance at which the ranging is possible or an effect of improving the ranging accuracy is obtained.

After counting the pulses, the pulse holding circuit 342 (first holding circuit) holds identification information indicating the count period and a pulse count value corresponding to the identification information. The comparison circuit 344 compares the past pulse count value held in the provisional ranking holding circuit 343 (the second holding circuit) with the pulse count value newly held in the pulse holding circuit 342. The comparison circuit 344 performs update process for newly holding the larger one of these pulse count values in the provisional ranking holding circuit 343. At the same time, identification information indicating the count period during which the held pulse count value is acquired is also held in the provisional ranking holding circuit 343. By repeating this processing for a predetermined number of count periods, the provisional ranking holding circuit 343 holds the maximum pulse count value and identification information indicating the count period corresponding to the maximum pulse count value. Then, the comparison circuit 344 reads the identification information indicating the count period corresponding to the maximum pulse count value from the provisional ranking holding circuit 343, and writes the identification information into the ranking information holding circuit 345 (third holding circuit). At this time, the information of the maximum pulse count value held in the provisional ranking holding circuit 343 and the count period corresponding to the maximum pulse count value may be deleted.

These operations are repeated, and light emission from the light emitting circuit 32 and detection of reflected light by the pulse generation circuit 33 and the processing circuit 34 are performed a predetermined number of times. Then, the output circuit 346 outputs the identification information indicating the count period corresponding to the maximum pulse count value held in the ranking information holding circuit 345 to the outside of the ranging device 30. This identification information can be used to calculate a distance from the ranging device 30 to the object 40.

When the ranging device 30 is a flash LiDAR, a plurality of pulse generation circuits 33 may be arranged to form a plurality of rows and a plurality of columns. The pulse holding circuit 342, the provisional ranking holding circuit 343, the comparison circuit 344 and the ranking information holding circuit 345 may also be arranged to form a plurality of rows and a plurality of columns so as to correspond to each of the plurality of pulse generation circuits 33. When there are a plurality of pulse generation circuits 33, the ranking information holding circuit 345 may not necessarily be arranged to form a plurality of rows and a plurality of columns. In this case, the ranking information holding circuit 345 may be arranged in a state of being integrated corresponding to the number of pixels. The data held in the plurality of provisional ranking holding circuits 343 can be read out by raster scanning for each light emission from the light emitting circuit 32.

FIG. 2 is a diagram illustrating an outline of the operation of the ranging device 30 according to the present embodiment in one ranging period. In the description of FIG. 2, it is assumed that the ranging device 30 is a flash LiDAR. In “ranging period” of FIG. 2, a plurality of frame periods FL1, FL2, and FL3 included in one ranging period are illustrated. The frame period FL1 indicates the first frame period in one ranging period, the frame period FL2 indicates the second frame period in one ranging period, and the frame period FL3 indicates the last frame period in one ranging period. The frame period is a period in which the ranging device 30 performs one ranging and outputs a signal indicating a distance (ranging result) from the ranging device 30 to the object 40 to the outside.

In “frame period” of FIG. 2, a plurality of shots SH1, SH2, . . . , SH3 and a peak output OUT included in the frame period FL1 are illustrated. The shot is a period in which the light emitting circuit 32 emits light once, the pulse generation circuit 33 and the processing circuit 34 generate a digital signal based on the light emission once, and the digital signal is held in the ranking information holding circuit 345. The shot SH1 indicates the first shot in the frame period FL1. The shot SH2 indicates the second shot in the frame period FL1. The shot SH3 indicates the last shot in the frame period FL1. The peak output OUT indicates a period during which a ranging result is output based on peaks obtained by accumulating signals of a plurality of shots.

In “shot” of FIG. 2, a plurality of bins BN1, BN2, . . . , BN3 included in the shot SH1 are illustrated. The “bin” is one count period during which the pulse holding circuit 342 counts pulses and holds one pulse count value. The bin BN1 indicates the first bin in the shot SH1. The bin BN2 indicates the second bin in the shot SH1. The bin BN3 indicates the last bin in shot SH1.

“Time counting” in FIG. 2 schematically illustrates pulses PL1 used for time counting in the time counting circuit 341 in the bin BN1. As illustrated in FIG. 2, the time counting circuit 341 counts the pulses PL1 that rise periodically to generate a time count value. When the time count value reaches a predetermined value, the bin BN1 ends, and the next bin BN2 starts. For example, when the period of the pulse PL1 is 0.1 microsecond, when the time count value changes from “0” to “10”, it can be determined that one microsecond has elapsed from the time when the time count value is “0”. Note that, it is assumed that the initial value of the time counting is “0”.

“Pulse counting” in FIG. 2 schematically illustrates pulses based on incident light output from the pulse generation circuit 33 in the bin BN1 and counted in the pulse holding circuit 342. When one photon is incident on the pulse generation circuit 33, one pulse PL2 rises. In the example of FIG. 2, two pulses rise in the period of the bin BN1, and “2” is held in the pulse holding circuit 342 as the pulse count value of the bin BN1. Similarly, pulse count values are sequentially acquired and held in and after the bin BN2. As illustrated in FIG. 2, the frequency of the pulse PL1 of the time counting is set sufficiently higher than the frequency of the rising edge of the pulse PL2 of the pulse counting. In this case, the number of pulses PL2 can be appropriately counted.

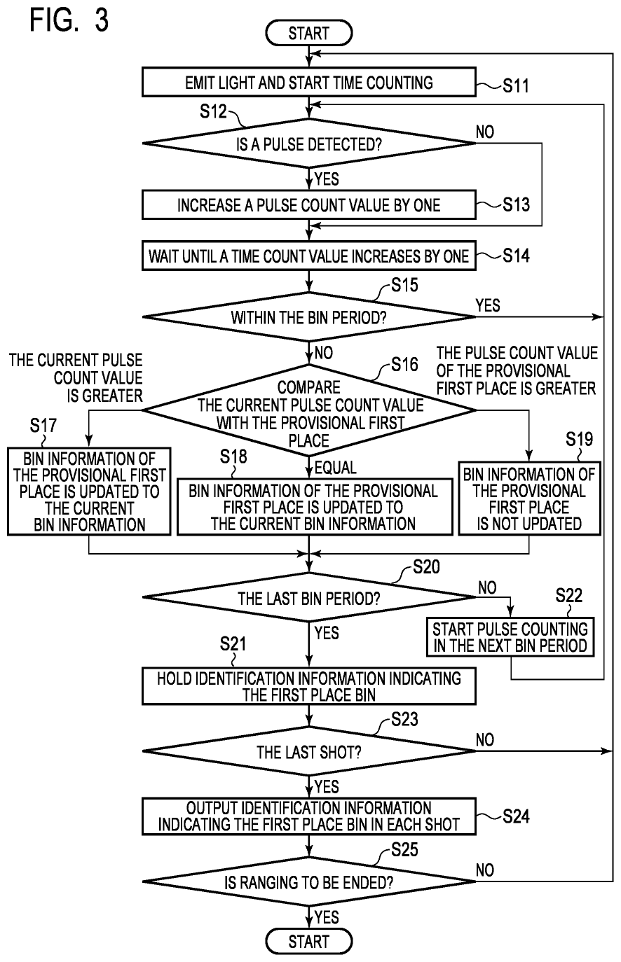

FIG. 3 is a flowchart illustrating the operation of the ranging device 30 according to the first embodiment in one ranging period. FIG. 3 schematically illustrates the operation of the ranging device 30 from the start to the end of one ranging period. That is, the flowchart in FIG. 3 illustrates an operation performed during a period from the start of the frame period FL1 to the end of the frame period FL3 in FIG. 2.

In step S11, the control circuit 31 controls the light emitting circuit 32, the pulse generation circuit 33, and the time counting circuit 341 to start the operation of one shot. The light emitting circuit 32 emits light to the outside of the ranging device 30. At the same time, the time counting circuit 341 starts time counting. The synchronization control of these start timings is performed by the control circuit 31.

The pulse generation circuit 33 receives light including reflected light from the object 40. The pulse generation circuit 33 converts the light into a pulsed signal by photoelectric conversion. The pulsed signal is input to the pulse holding circuit 342. The rising edge of the pulsed signal indicates that a photon is incident on the photoelectric conversion element.

In step S12, the pulse holding circuit 342 detects the rising edge of the pulse. When the pulse holding circuit 342 detects the rising edge of the pulse (YES in the step S12), the process proceeds to step S13. When the pulse holding circuit 342 does not detect the rising edge of the pulse (NO in the step S12), the process proceeds to step S14.

In the step S13, the pulse holding circuit 342 increases the held pulse count value by one. Then, the process proceeds to the step S14. It is assumed that the initial value of the pulse count value in the pulse holding circuit 342 is zero. In this case, the finally obtained pulse count value coincides with the number of rising edges of the input pulses, that is, the number of incident photons.

In the step S14, the processing circuit 34 waits until the time count value in the time counting circuit 341 increases by one. When the time count value increases by one with the passage of time, the process proceeds to step S15.

In the step S15, the pulse holding circuit 342 determines, based on the time count value, whether or not the current time is within the bin period during which the current pulse counting is performed. When the current time is within the current bin period (YES in the step S15), the process proceeds to the step S12, and the operation of detecting the pulses during the current bin period continues. When the current time is not within the current bin period (NO in the step S15), the process proceeds to step S16, and detection of pulses in the period of one bin ends. That is, the processing of the loop from the step S12 to the step S15 corresponds to the processing of one bin period in FIG. 2.

Next, in steps S16 to S19, the pulse holding circuit 342, the provisional ranking holding circuit 343, and the comparison circuit 344 perform processing of updating the pulse count value of a provisional first place. Here, the provisional first place refers to a bin whose pulse count value is the maximum among bins whose pulse count values have been acquired so far. The comparison circuit 344 compares the current pulse count value held in the pulse holding circuit 342 with the pulse count value of the provisional first place held in the provisional ranking holding circuit 343. When the current pulse count value is greater than the pulse count value of the provisional first place, the process proceeds to the step S17. When the current pulse count value and the pulse count value of the provisional first place are equal to each other, the process proceeds to the step S18. When the pulse count value of the provisional first place is greater than the current pulse count value, the process proceeds to the step S19.

In the step S17, the pulse count value held in the pulse holding circuit 342 is held in the provisional ranking holding circuit 343. As a result, the pulse count value of the provisional first place is updated to the current pulse count value. At the same time, the provisional ranking holding circuit 343 holds identification information indicating a bin in which a newly held pulse count value is acquired (for example, a bin number k indicating that the bin is the k-th bin). Then, the process proceeds to step S20. The pulse count value and the identification information indicating the bin held in the provisional ranking holding circuit 343 are sometimes referred to as bin information.

In the step S19, the processing of updating the bin information of the provisional first place is not performed, and the process proceeds to the step S20. That is, the provisional ranking holding circuit 343 keeps the bin information of the original provisional first place as it is.

In the step S18, an update process similar to the step S17 or an update process similar to the step S19 is performed. FIG. 3 illustrates an example in which the update process in the step S18 and the update process in the step S17 are the same, but the present embodiment is not limited thereto, and the update process in the step S18 may be the same as the update process in the step S19. That is, in step S18, the bin information of the provisional first place may be updated or may not be updated. In the case of the updating is performed, since the bin information being input later is held preferentially, the ranging is performed with priority given to the long distance. On the other hand, in the case of the updating is not performed, since the previously input bin information is held preferentially, the ranging is performed with priority given to the short distance.

At the end of the first bin period in one shot period, bin information of the provisional first place has not held in the provisional ranking holding circuit 343. Therefore, when the first bin period is finished, the comparison of step S16 is not performed exceptionally, and the pulse count value of the first bin period and information specifying the first bin period are held in the provisional ranking holding circuit 343 as the bin information of the provisional first place.

In the step S20, the processing circuit 34 determines whether or not the bin period that has been processed immediately before is the last bin period. When the bin period that has been processed immediately before is the last bin period (YES in the step S20), the processing proceeds to step S21, and the acquisition of the measurement result for one shot is finished. When the bin period that has been processed immediately before is not the last bin period (NO in the step S20), the processing proceeds to step S22.

In the step S22, the processing circuit 34 performs switching processing for obtaining the pulse count value in the next bin period. In this processing, the pulse holding circuit 342 resets the held pulse count value. Then, the processing proceeds to the step S12, and the pulse counting in the next bin period starts. In this manner, the holding operation of the pulse count values in a plurality of bin periods is sequentially performed by the number of bin periods. Then, when the newly obtained pulse count value is the maximum among the past pulse count values, the bin information update process of the provisional first place is performed.

In the step S21, the ranking information holding circuit 345 acquires and holds identification information indicating the first place bin in one shot from the bin information held in the provisional ranking holding circuit 343 at the end of the last bin period.

In step S23, the control circuit 31 and the processing circuit 34 determine whether or not the shot that has been processed immediately before is the last shot period. When the shot that has been processed immediately before is the last shot (YES in the step S23), the processing proceeds to step S24, and the acquisition of the measurement result in one frame period ends. When the shot that has been processed immediately before is not the last shot (NO in the step S23), the processing proceeds to the step S11. In this case, after the information such as the pulse count values held in the pulse holding circuit 342 and the provisional ranking holding circuit 343 is reset, the next shot is measured. In this way, measurements of a plurality of shots are sequentially performed by the number of shots in one frame period.

In the step S24, the output circuit 346 reads the identification information indicating the first place bin in each shot in one frame period from the ranking information holding circuit 345, and outputs the identification information to the outside of the ranging device 30. Since the first place bin in each shot is a bin where the pulse count value is a peak in each shot, this processing corresponds to the peak output OUT in FIG. 2. As a result, the ranging and the signal output in one frame period are finished, and the processing proceeds to step S25.

In the step S25, the control circuit 31 determines whether or not to end the ranging in the ranging device 30. When it is determined that the ranging is to be ended (YES in the step S25), the process ends. When it is determined that the ranging is not to be ended (NO in the step S25), the process proceeds to the step S11, and the ranging in the next frame period is started. This determination may be based on, for example, a control signal or the like from a device on which the ranging device 30 is mounted.

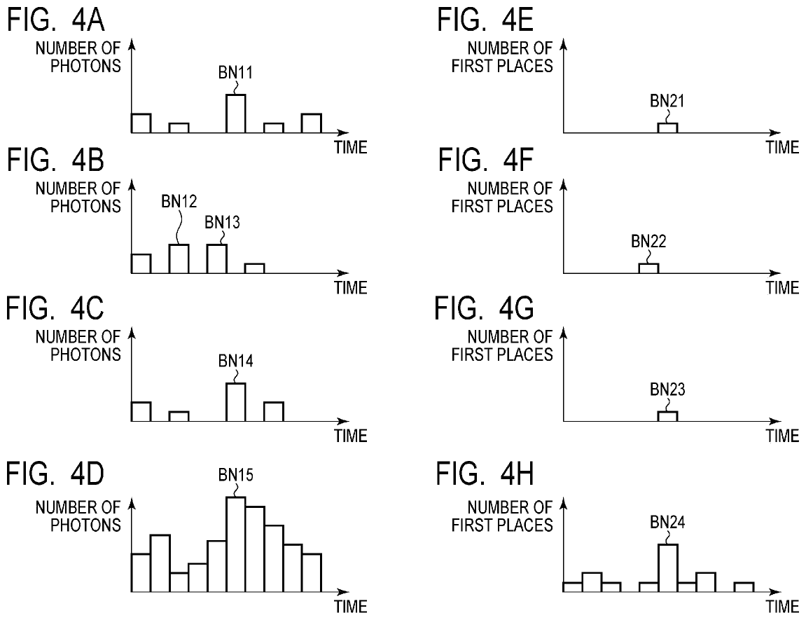

FIGS. 4A to 4H are diagrams schematically illustrating information held in the ranking information holding circuit 345. FIGS. 4A, 4B, and 4C illustrate examples of histograms of the numbers of photons (corresponding to pulse count values) in the first shot, the second shot, and the third shot, respectively. FIG. 4D illustrates an example of a histogram in which the number of photons is integrated over all shots. The horizontal axis represents the elapsed time from light emission. An interval of the histogram corresponds to one bin period during which photon detection is performed. The vertical axis represents the number of photons detected in each bin period. FIGS. 4E, 4F, and 4G are examples of histograms illustrating the number of times in which the pulse count value is the first place in each bin period in the first shot, the second shot, and the third shot, respectively. FIG. 4H illustrates an example of a histogram in which the number of times of the first place is integrated over all shots.

Each of FIGS. 4E, 4F, 4G, and 4H illustrates the frequency distribution of the first place bin held in the ranking information holding circuit 345 visually in the form of a histogram in the ranging device 30 of the present embodiment. In the ranging device 30 of the present embodiment, the provisional ranking holding circuit 343 can hold only bin information of the provisional first place, and bin information of the second place or lower is lost during the update process. Therefore, although the frequency distribution of the number of photons necessary for generating the histogram as illustrated in FIGS. 4A to 4D is not actually obtained, an example in which it is assumed that the frequency distribution of the number of photons of all bins can be obtained for explanation is illustrated in FIGS. 4A to 4D.

As illustrated in FIG. 4A, in the first shot, the number of photons of the sixth bin BN11 is the first place among all bins. Therefore, as illustrated in FIG. 4E, in the first shot, information for counting once that the sixth bin BN21 is the first place is held in the ranking information holding circuit 345.

As illustrated in FIG. 4B, in the second shot, the number of photons of the third bin BN12 and the number of photons of the fifth bin BN13 are the first place among all bins. As illustrated in the step S18 of FIG. 3, in the present embodiment, since updating is performed even when the number of pulse counts is the same, when there are a plurality of bins of the first place, information of bins being input later is held in the ranking information holding circuit 345. Therefore, as illustrated in FIG. 4F, in the second shot, information for counting once that the fifth bin BN22 is the first place is held in the ranking information holding circuit 345.

FIGS. 4C and 4G are similar to FIGS. 4A and 4E. That is, in the third shot, the ranking information holding circuit 345 holds information for counting once that the sixth bin BN23 is the first place.

The same processing is performed for the other shots, and information indicating the number of times of the first place in each shot is held in the ranking information holding circuit 345. As a result, as illustrated in FIG. 4H, the ranking information holding circuit 345 holds information corresponding to the frequency distribution in which the number of times of the first place is integrated over all shots. The shape of the histogram of FIG. 4D and the shape of the histogram of FIG. 4H are quite different from each other. However, as illustrated in FIGS. 4D and 4H, the position of the sixth bin BN24 which is the peak in FIG. 4H coincides with the position of the sixth bin BN15 which is the peak in FIG. 4D. The time corresponding to the bin at the peak of the histogram corresponds to the time until light is emitted from the light emitting circuit 32, reflected by the object 40, and incident on the pulse generation circuit 33, and is therefore used for calculating the distance. Therefore, even in the method of the present embodiment using only the frequency distribution of the number of times of the first place as illustrated in FIG. 4H, the distance information necessary for the ranging can be appropriately acquired as in the case of using the frequency distribution of the number of photons of all bins as illustrated in FIG. 4D.

In the present embodiment, by holding only the identification information indicating the bin of the first place of each shot, it is possible to output the frequency distribution of the number of times of the first place, so that the ranging can be performed without holding the information of the second place or lower with little contribution to the ranging in the memory. Therefore, the ranging device 30 of the present embodiment can appropriately acquire information necessary for ranging even when the storage capacity of the memory is reduced. Therefore, according to the present embodiment, the ranging device 30 with reduced storage capacity while maintaining ranging accuracy is provided.

In the processing from the step S16 to the step S19 in FIG. 3, when the current pulse count value is equal to the pulse count value of the provisional first place, the processing of updating the bin information of the provisional first place is performed. As a result, when there are two peaks as illustrated in FIG. 4B, the bin information that is input later is held in the ranking information holding circuit 345 as the bin information of the first place. However, the present embodiment is not limited thereto. By configuring the provisional ranking holding circuit 343 so that two or more pieces of bin information of the provisional first place can be held, when the pulse count values are equal, a plurality of pieces of bin information of the provisional first place may be held.

In the present embodiment, although only the bin information of the first place is held and the bin information of the second place or lower is not held, higher bin information other than the first place such as bin information of the second place and the third place may also be used for distance calculation. For example, N is an integer equal to or greater than one, and the configuration of the provisional ranking holding circuit 343 is modified so that the higher N sets of bin information from the provisional first place to the provisional N-th place can be held. Then, in the comparison of the pulse count values from the step S16 to the step S19, the same processing is possible by holding N sets of bin information from the provisional first place to the provisional N-th place in the provisional ranking holding circuit 343, and updating so as not to hold bin information of the (N+1)-th or lower place. In this case, the ranking information holding circuit 345 may be configured to hold the frequency distributions of the N bins from the first place to the N-th place. Since the bin information lower than the first bin information is also used for the ranging (that is, N is equal to or greater than 2), it is possible to reduce the possibility of erroneous detection of the distance even in an environment where noise is large, in which environmental light larger than the reflected light from the object 40 can be incident. However, in this case, since the storage capacity of the memory increases as compared with the case of using only the first bin information, in a general environment in which the environmental light is not so large, it is desirable to use only the bin information of the first place (that is, N is equal to 1) as in the example of FIG. 3.

In the present embodiment, the output circuit 346 outputs the bin information of the first place in each shot, but the information output from the output circuit 346 to the outside of the ranging device 30 is not limited thereto. For example, by calculating the distance between the ranging device 30 and the object 40 inside the ranging device 30 using the information held in the ranking information holding circuit 345, the output circuit 346 may output the distance information to the outside of the ranging device 30.

In FIG. 4E to FIG. 4H, bins which are the first place in one shot contribute as one count in the frequency distribution after integration. However, the degree of contribution to the frequency distribution may be changed according to the magnitude of the pulse count value of the bin of the first place. For example, when the pulse count value is equal to or less than a predetermined threshold value, the count may be one count, and when the pulse count value exceeds the predetermined threshold value, the count may be two count.

### Second Embodiment

In the present embodiment, a modified example of the format of information held in the ranking information holding circuit 345 will be described. Other elements are the same as those in the first embodiment, and thus description thereof will be omitted. In the present embodiment, it is assumed that the provisional ranking holding circuit 343 is configured to hold two or more pieces of bin information of the provisional first place. As a result, when the pulse count values are equal in the two or more bins, the provisional ranking holding circuit 343 of the present embodiment holds information of both of the two or more bins as the bin information of the first place.

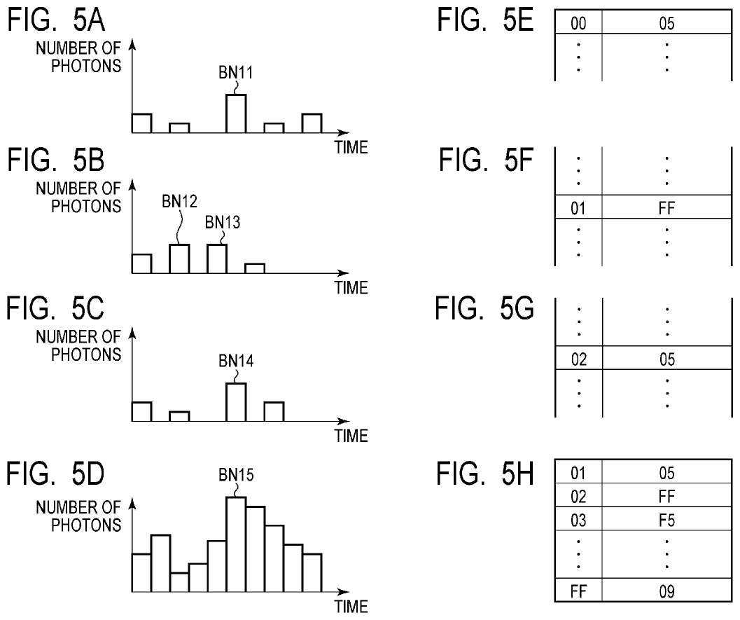

FIGS. 5A to 5H are diagrams schematically illustrating information held in the ranking information holding circuit 345. Histograms of the numbers of photons illustrated in FIGS. 5A to 5D are the same as those illustrated in FIGS. 4A to 4D.

FIGS. 5E, 5F, and 5G illustrate, in a table format, the bin numbers whose pulse count values are the first place in the first shot, the second shot, and the third shot, respectively. FIG. 5H illustrates, in a table format, bin numbers of bins whose pulse count values are the first place in all shots. In FIGS. 5E, 5F, 5G, and 5H, the left column indicates shot numbers and the right column indicates bin numbers. These numbers are denoted by two digits of hexadecimal numbers, and it is assumed that “00” corresponds to the first shot or the first bin.

As illustrated in FIG. 5A, in the first shot, the number of photons of the sixth bin BN11 is the first place among all bins. Therefore, as illustrated in FIG. 5E, the ranking information holding circuit 345 holds the bin number “05” indicating the sixth bin so as to correspond to the shot number “00” indicating the first shot.

As illustrated in FIG. 5B, in the second shot, the number of photons of the third bin BN12 and the number of photons of the fifth bin BN13 are the first place among all bins. In this case, as illustrated in FIG. 5F, the ranking information holding circuit 345 holds a number “FF” indicating that the bin of the first place corresponding to the shot number “01” indicating the second shot cannot be specified. Note that, the number “FF” may be any value that can be distinguished from other bin numbers, and is not limited thereto.

As illustrated in FIG. 5C, in the third shot, the number of photons of the sixth bin BN14 is the first place among all bins. Therefore, as illustrated in FIG. 5G, the ranking information holding circuit 345 holds the bin number “05” indicating the sixth bin so as to correspond to the shot number “02” indicating the third shot.

Similar processing is performed for the other shots, and as illustrated in FIG. 5H, the shot numbers are associated with the bin numbers of the first place and held in the ranking information holding circuit 345. This information can be used for ranging similarly to the frequency distribution in the first embodiment. Therefore, also in the present embodiment, similarly to the first embodiment, information necessary for ranging can be appropriately acquired.

In the present embodiment, the configuration capable of holding and outputting the bin number of the first place of each shot makes it possible to carry out the ranging without holding the information of the second place or lower with little contribution to the ranging in the memory. Therefore, the ranging device 30 of the present embodiment can appropriately acquire information necessary for ranging even when the storage capacity of the memory is reduced. Therefore, according to the present embodiment, the ranging device 30 with reduced storage capacity while maintaining ranging accuracy is provided.

When the bin numbers are held in a specific order from a specific address of the memory, the shot numbers are not necessarily held. In this case, since the external control device can determine the shot number based on the address of the memory, the ranging processing can be performed even when the shot number itself is not stored. In this configuration example, the storage capacity can be further reduced.

In the example of FIGS. 5B and 5F, the number “FF” may be replaced with a bin number “02” indicating the third bin. In this way, when there are a plurality of bins of the first place, by prioritizing the bin number in the earlier time, it is possible to perform ranging with prioritizing the short distance. Also, in the examples of FIGS. 5B and 5F, the number “FF” may be replaced with a bin number “04” indicating the fifth bin. In this way, when there are a plurality of bins of the first place, by prioritizing the bin number in the later time, it is possible to perform ranging prioritizing the long distance. When there are three or more bins of the first place, a bin number indicating a bin at their median values may be held. Although the storage capacity increases, when there are a plurality of bins of the first place, all of those bins may be held.

In the present embodiment, although only the bin information of the first place is held and the bin information of the second place or less is not held, higher bin information other than the first place such as bin information of the second place and the third place may also be used for distance calculation. For example, N is an integer equal to or greater than one, and the configuration of the provisional ranking holding circuit 343 is modified so that the higher N sets of bin information from the provisional first place to the provisional N-th place can be held. Then, in the comparison of the pulse count values from the step S16 to step the S19, the same processing is possible by holding N sets of bin information from the provisional first place to the provisional N-th place in the provisional ranking holding circuit 343, and updating so as not to hold bin information of the (N+1)-th or lower place. In this case, the ranking information holding circuit 345 may be configured to hold bin numbers from the first place to the N-th place. Since the bin number lower than the first bin number for the ranging (that is, N is equal to or greater than 2), it is possible to reduce the possibility of erroneous detection of the distance even in an environment where noise is large, in which environmental light larger than the reflected light from the object 40 can be incident. However, in this case, since the storage capacity of the memory increases as compared with the case of using only the first bin information, in a general environment in which the environmental light is not so large, it is desirable to use only the bin information of the first place (that is, N is equal to 1) as in the example of FIG. 3.

In the present embodiment, the output circuit 346 outputs the bin number of the first place in each shot, but the information output from the output circuit 346 to the outside of the ranging device is not limited thereto. For example, by calculating the distance between the ranging device 30 and the object 40 inside the ranging device 30 using the bin number held in the ranking information holding circuit 345, the output circuit 346 may output the distance information to the outside of the ranging device 30.

In FIG. 5H, bins that is the first place in each shot may be similar contributions in the ranging processing, or may be different contributions by giving predetermined weightings. For example, the weighting coefficient may be changed according to the magnitude of the pulse count value of the bin of the first place. For example, the weighting coefficient may be set to “1” when the pulse count value is equal to or less than a predetermined threshold value, and may be set to “2” when the pulse count value exceeds the predetermined threshold value.

### Third Embodiment

In the present embodiment, a modified example of the configuration of the pulse generation circuit 33 in the ranging device 30 will be described. Other elements are similar to those of the first embodiment or the second embodiment, and thus description thereof will be omitted.

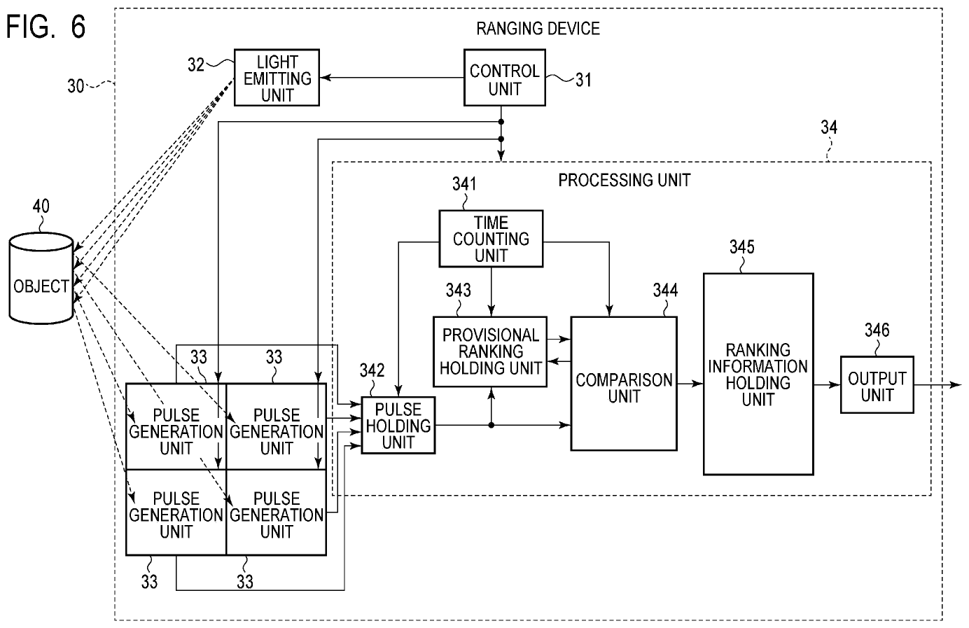

FIG. 6 is a block diagram illustrating a schematic configuration example of the ranging device 30 according to the present embodiment. The ranging device 30 of the present embodiment includes pulse generation circuits 33 arranged to form a plurality of rows and a plurality of columns. Each of the plurality of pulse generation circuits 33 can be controlled by the control circuit 31. The pulsed signal output from each of the plurality of pulse generation circuits 33 is input to one pulse holding circuit 342. Each of the plurality of pulse generation circuits 33 outputs a unique value (coordinate information) indicating coordinates together with the pulsed signal. Thus, the pulse holding circuit 342 can identify the pulse generation circuit 33 that has output the pulsed signal. Although the plurality of pulse generation circuits 33 are arranged in two rows and two columns in FIG. 6, the number of rows and the number of columns are not limited thereto, and may be appropriately set.

The provisional ranking holding circuit 343 is configured to hold pulse count values of pulsed signals output from the pulse generation circuits 33. The comparison circuit 344 may be configured to be capable of parallel processing of comparison processing of pulse count value corresponding to each of the plurality of pulse generation circuits 33, or may be configured to be capable of sequentially processing by time division.

When the frequency of generation of pulses based on incident light from the plurality of pulse generation circuits 33 is small, even if one pulse holding circuit 342 performs pulse counting of pulsed signals output from the plurality of pulse generation circuits 33, the influence on the accuracy of ranging is small. Therefore, in such a case, by arranging one pulse holding circuit 342 corresponding to the plurality of pulse generation circuits 33, the scale of the circuits arranged around the pulse generation circuits 33 is reduced.

In the configuration of the present embodiment, it is not essential to arrange a large number of circuits constituting the provisional ranking holding circuit 343, the time counting circuit 341, the comparison circuit 344, and the ranking information holding circuit 345 in the vicinity of the plurality of pulse generation circuits 33. Therefore, the area of the light receiving portion such as the avalanche photodiode in the pulse generation circuit 33 can be enlarged, and the sensitivity can be improved.

According to the present embodiment, in addition to the effects similar to those of the first embodiment or the second embodiment, the ranging device 30 in which the scale of the circuits arranged around the pulse generation circuit 33 is reduced is provided.

### Fourth Embodiment

In the present embodiment, a specific configuration example of a photoelectric conversion device that includes an avalanche photodiode and that can be applied to the control circuit 31, the pulse generation circuit 33, and the processing circuit 34 in the ranging device 30 according to the first to third embodiments will be described. The configuration example of the present embodiment is an example, and the photoelectric conversion device applicable to the ranging device 30 is not limited thereto.

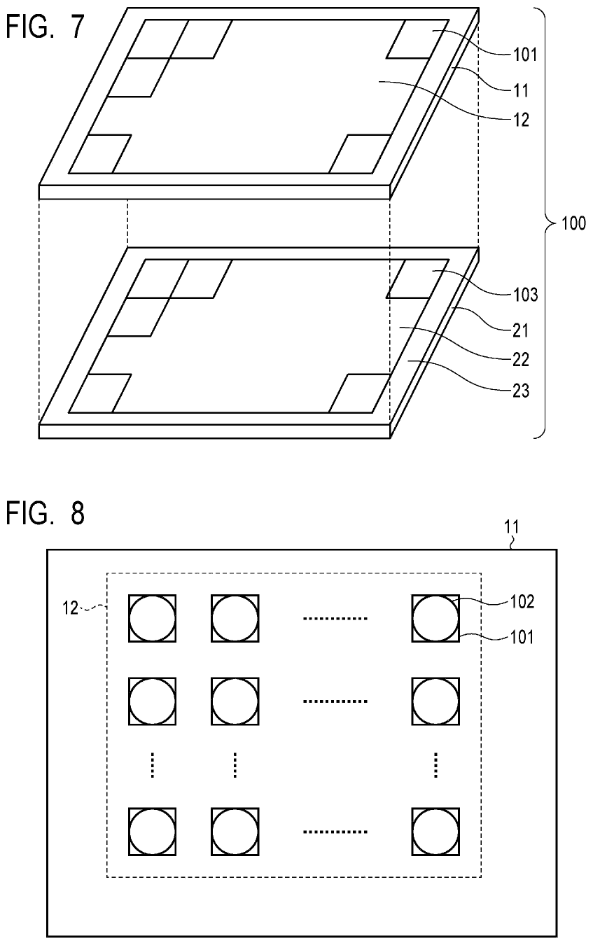

FIG. 7 is a schematic diagram illustrating an overall configuration of the photoelectric conversion device 100 according to the present embodiment. The photoelectric conversion device 100 includes a sensor substrate 11 (first substrate) and a circuit substrate 21 (second substrate) stacked on each other. The sensor substrate 11 and the circuit substrate 21 are electrically connected to each other. The sensor substrate 11 has a pixel region 12 in which a plurality of pixels 101 are arranged to form a plurality of rows and a plurality of columns. The circuit substrate 21 includes a first circuit region 22 in which a plurality of pixel signal processing circuits 103 are arranged to form a plurality of rows and a plurality of columns, and a second circuit region 23 arranged outside the first circuit region 22. The second circuit region 23 may include a circuit for controlling the plurality of pixel signal processing circuits 103. The sensor substrate 11 has a light incident surface for receiving incident light and a connection surface opposed to the light incident surface. The sensor substrate 11 is connected to the circuit substrate 21 on the connection surface side. That is, the photoelectric conversion device 100 is a so-called backside illumination type.

In this specification, the term “plan view” refers to a view from a direction perpendicular to a surface opposite to the light incident surface. The cross section indicates a surface in a direction perpendicular to a surface opposite to the light incident surface of the sensor substrate 11. Although the light incident surface may be a rough surface when viewed microscopically, in this case, a plan view is defined with reference to the light incident surface when viewed macroscopically.

In the following description, the sensor substrate 11 and the circuit substrate 21 are diced chips, but the sensor substrate 11 and the circuit substrate 21 are not limited to chips. For example, the sensor substrate 11 and the circuit substrate 21 may be wafers. When the sensor substrate 11 and the circuit substrate 21 are diced chips, the photoelectric conversion device 100 may be manufactured by being diced after being stacked in a wafer state, or may be manufactured by being stacked after being diced.

FIG. 8 is a schematic block diagram illustrating an arrangement example of the sensor substrate 11. In the pixel region 12, a plurality of pixels 101 are arranged to form a plurality of rows and a plurality of columns. Each of the plurality of pixels 101 includes a photoelectric conversion unit or circuit 102 including an avalanche photodiode (hereinafter referred to as APD) as a photoelectric conversion element in the substrate.

Of the charge pairs generated in the APD, the conductivity type of the charge used as the signal charge is referred to as a first conductivity type. The first conductivity type refers to a conductivity type in which a charge having the same polarity as the signal charge is a majority carrier. Further, a conductivity type opposite to the first conductivity type, that is, a conductivity type in which a majority carrier is a charge having a polarity different from that of a signal charge is referred to as a second conductivity type. In the APD described below, the anode of the APD is set to a fixed potential, and a signal is extracted from the cathode of the APD. Accordingly, the semiconductor region of the first conductivity type is an N-type semiconductor region, and the semiconductor region of the second conductivity type is a P-type semiconductor region. Note that the cathode of the APD may have a fixed potential and a signal may be extracted from the anode of the APD. In this case, the semiconductor region of the first conductivity type is the P-type semiconductor region, and the semiconductor region of the second conductivity type is then N-type semiconductor region. Although the case where one node of the APD is set to a fixed potential is described below, potentials of both nodes may be varied.

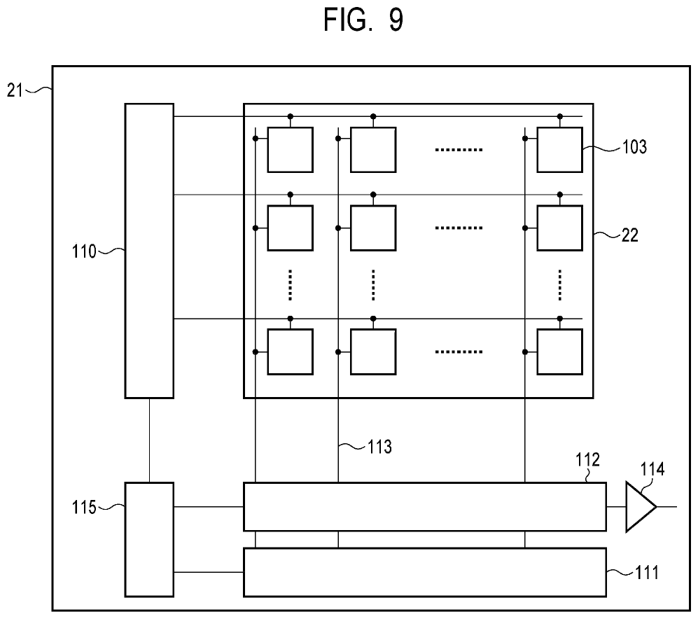

FIG. 9 is a schematic block diagram illustrating a configuration example of the circuit substrate 21. The circuit substrate 21 has the first circuit region 22 in which a plurality of pixel signal processing circuits 103 are arranged to form a plurality of rows and a plurality of columns.

The circuit substrate 21 includes a vertical scanning circuit 110, a horizontal scanning circuit 111, a reading circuit 112, a pixel output signal line 113, an output circuit 114, and a control signal generation unit or circuit 115. The plurality of photoelectric conversion circuits 102 illustrated in FIG. 8 and the plurality of pixel signal processing circuits 103 illustrated in FIG. 9 are electrically connected to each other via connection wirings provided for each pixels 101.

The control signal generation circuit 115 is a control circuit that generates control signals for driving the vertical scanning circuit 110, the horizontal scanning circuit 111, and the reading circuit 112, and supplies the control signals to these circuits. As a result, the control signal generation circuit 115 controls the driving timings and the like of each circuit.

The vertical scanning circuit 110 supplies control signals to each of the plurality of pixel signal processing circuits 103 based on the control signal supplied from the control signal generation circuit 115. The vertical scanning circuit 110 supplies control signals for each row to the pixel signal processing circuit 103 via a driving line provided for each row of the first circuit region 22. As will be described later, a plurality of driving lines may be provided for each row. A logic circuit such as a shift register or an address decoder can be used for the vertical scanning circuit 110. Thus, the vertical scanning circuit 110 selects a row to be output a signal from the pixel signal processing circuit 103.

The signal output from the photoelectric conversion circuit 102 of the pixels 101 is processed by the pixel signal processing circuit 103. The pixel signal processing circuit 103 acquires and holds a digital signal having a plurality of bits by counting the number of pulses output from the APD included in the photoelectric conversion circuit 102.

It is not always necessary to provide one pixel signal processing circuit 103 for each of the pixels 101. For example, one pixel signal processing circuit 103 may be shared by a plurality of pixels 101. In this case, the pixel signal processing circuit 103 sequentially processes the signals output from the photoelectric conversion circuits 102, thereby providing the function of signal processing to each pixel 101.

The horizontal scanning circuit 111 supplies control signals to the reading circuit 112 based on a control signal supplied from the control signal generation circuit 115. The pixel signal processing circuit 103 is connected to the reading circuit 112 via a pixel output signal line 113 provided for each column of the first circuit region 22. The pixel output signal line 113 in one column is shared by a plurality of pixel signal processing circuits 103 in the corresponding column. The pixel output signal line 113 includes a plurality of wirings, and has at least a function of outputting a digital signal from the pixel signal processing circuit 103 to the reading circuit 112, and a function of supplying a control signal for selecting a column for outputting a signal to the pixel signal processing circuit 103. The reading circuit 112 outputs a signal to an external storage circuit or signal processing circuit of the photoelectric conversion device 100 via the output circuit 114 based on the control signal supplied from the control signal generation circuit 115.

The arrangement of the photoelectric conversion circuits 102 in the pixel region 12 may be one-dimensional. Further, the function of the pixel signal processing circuit 103 does not necessarily have to be provided one by one in all the pixels 101. For example, one pixel signal processing circuit 103 may be shared by a plurality of pixels 101. In this case, the pixel signal processing circuit 103 sequentially processes the signals output from the photoelectric conversion circuits 102, thereby providing the function of signal processing to each pixel 101.

As illustrated in FIGS. 8 and 9, the first circuit region 22 having a plurality of pixel signal processing circuits 103 is arranged in a region overlapping the pixel region 12 in the plan view. In the plan view, the vertical scanning circuit 110, the horizontal scanning circuit 111, the reading circuit 112, the output circuit 114, and the control signal generation circuit 115 are arranged so as to overlap a region between an edge of the sensor substrate 11 and an edge of the pixel region 12. In other words, the sensor substrate 11 includes the pixel region 12 and a non-pixel region arranged around the pixel region 12. In the circuit substrate 21, the second circuit region 23 having the vertical scanning circuit 110, the horizontal scanning circuit 111, the reading circuit 112, the output circuit 114, and the control signal generation circuit 115 is arranged in a region overlapping with the non-pixel region in the plan view.

Note that the arrangement of the pixel output signal line 113, the arrangement of the reading circuit 112, and the arrangement of the output circuit 114 are not limited to those illustrated in FIG. 9. For example, the pixel output signal lines 113 may extend in the row direction, and may be shared by a plurality of pixel signal processing circuits 103 in corresponding rows. The reading circuit 112 may be provided so as to be connected to the pixel output signal line 113 of each row.

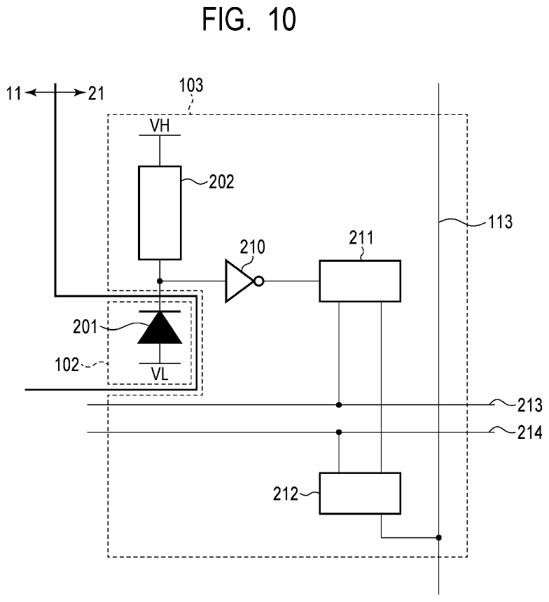

FIG. 10 is a schematic block diagram illustrating a configuration example of one pixel of the photoelectric conversion circuit 102 and the pixel signal processing circuit 103 according to the present embodiment. FIG. 10 schematically illustrates a more specific configuration example including a connection relationship between the photoelectric conversion circuit 102 arranged in the sensor substrate 11 and the pixel signal processing circuit 103 arranged in the circuit substrate 21. In FIG. 10, driving lines between the vertical scanning circuit 110 and the pixel signal processing circuit 103 in FIG. 9 are illustrated as driving lines 213 and 214.

The photoelectric conversion circuit 102 includes an APD 201. The pixel signal processing circuit 103 includes a quenching element 202, a waveform shaping unit or circuit 210, a counter circuit 211, and a selection circuit 212. The pixel signal processing circuit 103 may include at least one of the waveform shaping circuit 210, the counter circuit 211, and the selection circuit 212.

The APD 201 generates charge pairs corresponding to incident light by photoelectric conversion. A voltage VL (first voltage) is supplied to the anode of the APD 201. The cathode of the APD 201 is connected to a first terminal of the quenching element 202 and an input terminal of the waveform shaping circuit 210. A voltage VH (second voltage) higher than the voltage VL supplied to the anode is supplied to the cathode of the APD 201. As a result, a reverse bias voltage that causes the APD 201 to perform the avalanche multiplication operation is supplied to the anode and the cathode of the APD 201. In the APD 201 to which the reverse bias voltage is supplied, when a charge is generated by the incident light, this charge causes avalanche multiplication, and an avalanche current is generated.

The operation modes in the case where a reverse bias voltage is supplied to the APD 201 include a Geiger mode and a linear mode. The Geiger mode is a mode in which a potential difference between the anode and the cathode is higher than a breakdown voltage, and the linear mode is a mode in which a potential difference between the anode and the cathode is near or lower than the breakdown voltage.

The APD operated in the Geiger mode is referred to as a single photon avalanche diode (SPAD). In this case, for example, the voltage VL (first voltage) is −30 V, and the voltage VH (second voltage) is 1 V. The APD 201 may operate in the linear mode or the Geiger mode. In the case of the SPAD, a potential difference becomes greater than that of the APD of the linear mode, and the effect of avalanche multiplication becomes significant, so that the SPAD is preferable.

The quenching element 202 functions as a load circuit (quenching circuit) when a signal is multiplied by avalanche multiplication. The quenching element 202 suppresses the voltage supplied to the APD 201 and suppresses the avalanche multiplication (quenching operation). Further, the quenching element 202 returns the voltage supplied to the APD 201 to the voltage VH by passing a current corresponding to the voltage drop due to the quenching operation (recharge operation). The quenching element 202 may be, for example, a resistive element.

The waveform shaping circuit 210 shapes the potential change of the cathode of the APD 201 obtained at the time of photon detection, and outputs a pulse signal. For example, an inverter circuit is used as the waveform shaping circuit 210. Although FIG. 10 illustrates an example in which one inverter is used as the waveform shaping circuit 210, the waveform shaping circuit 210 may be a circuit in which a plurality of inverters are connected in series, or may be another circuit having a waveform shaping effect.

The counter circuit 211 counts the pulse signals output from the waveform shaping circuit 210, and holds a digital signal indicating the count value. When a control signal is supplied from the vertical scanning circuit 110 illustrated in FIG. 9 through the driving line 213 illustrated in FIG. 10, the counter circuit 211 resets the held signal.

The selection circuit 212 is supplied with a control signal from the vertical scanning circuit 110 illustrated in FIG. 9 through the driving line 214 illustrated in FIG. 10 response to this control signal, the selection circuit 212 switches between the electrical connection and the non-connection of the counter circuit 211 and the pixel output signal line 113. The selection circuit 212 includes, for example, a buffer circuit or the like for outputting a signal corresponding to a value held in the counter circuit 211.

In the example of FIG. 10, the selection circuit 212 switches between the electrical connection and the non-connection of the counter circuit 211 and the pixel output signal line 113; however, the method of controlling the signal output to the pixel output signal line 113 is not limited thereto. For example, a switch such as a transistor may be arranged at a node such as between the quenching element 202 and the APD 201 or between the photoelectric conversion circuit 102 and the pixel signal processing circuit 103, and the signal output to the pixel output signal line 113 may be controlled by switching the electrical connection and the non-connection. Alternatively, the signal output to the pixel output signal line 113 may be controlled by changing the value of the voltage VH or the voltage VL supplied to the photoelectric conversion circuit 102 using a switch such as a transistor.

FIG. 10 illustrates a configuration example using the counter circuit 211. However, instead of the counter circuit 211, a time-to-digital converter (TDC) and a memory may be used to acquire a timing at which a pulse is detected. In this case, the generation timing of the pulsed signal output from the waveform shaping circuit 210 is converted into a digital signal by the TDC. In this case, a control signal (reference signal) can be supplied from the vertical scanning circuit 110 illustrated in FIG. 9 to the TDC via the driving line. The TDC acquires, as a digital signal, a signal indicating a relative time of input timing of a pulse with respect to the control signal.

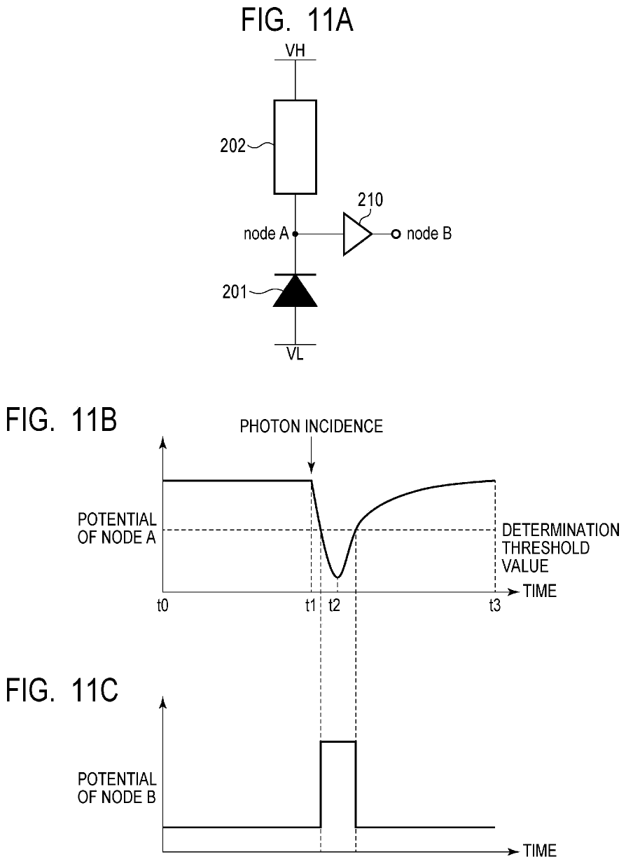

FIGS. 11A, 11B, and 11C are diagrams illustrating an operation of the APD 201 according to the present embodiment. FIG. 11A is a diagram illustrating the APD 201, the quenching element 202, and the waveform shaping unit 210 in FIG. 10. As illustrated in FIG. 11A, the connection node of the APD 201, the quenching element 202, and the input terminal of the waveform shaping circuit 210 is referred to as node A. Further, as illustrated in FIG. 11A, an output side of the waveform shaping circuit 210 is referred to as node B.

FIG. 11B is a graph illustrating a temporal change in the potential of node A in FIG. 11A. FIG. 11C is a graph illustrating a temporal change in the potential of node B in FIG. 11A. During a period from time t0 to time t1, the voltage VH-VL is applied to the APD 201 in FIG. 11A. When a photon enters the APD 201 at the time t1, avalanche multiplication occurs in the APD 201. As a result, an avalanche current flows through the quenching element 202, and the potential of the node A drops. Thereafter, the amount of potential drop further increases, and the voltage applied to the APD 201 gradually decreases. Then, at time t2, the avalanche multiplication in the APD 201 stops. Thereby, the voltage level of node A does not drop below a certain constant value. Then, during a period from the time t2 to time t3, a current that compensates for the voltage drop flows from the node of the voltage VH to the node A, and the node A is settled to the original potential at the time t3.

In the above-described process, the potential of node B becomes the high level in a period in which the potential of node A is lower than a certain threshold value. In this way, the waveform of the drop of the potential of the node A caused by the incidence of the photon is shaped by the waveform shaping circuit 210 and output as a pulse to the node B.

The pulse generation circuit 33 in the first to third embodiments to, for example, the APD 201, the quenching element 202, and the waveform shaping circuit 210 of the present embodiment. The control circuit 31 in the first to third embodiments corresponds to, for example, the control signal generation circuit 115, the vertical scanning circuit 110, and the horizontal scanning circuit 111 of the present embodiment. The processing circuit 34 in the first to third embodiments corresponds to, for example, another circuit of the present embodiment.

According to the present embodiment, a photoelectric conversion device using an avalanche photodiode which can be applied to the ranging device 30 of the first to third embodiments is provided.

### Fifth Embodiment

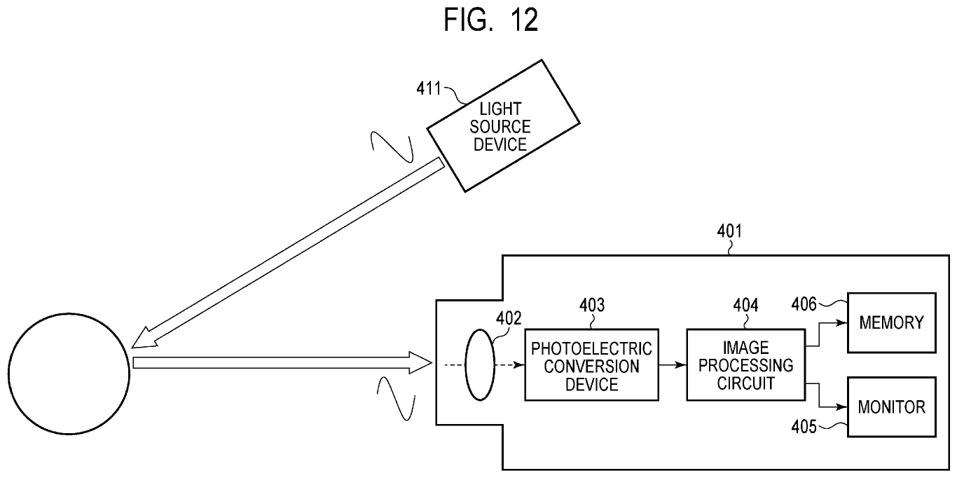

FIG. 12 is a block diagram of a photodetection system according to the present embodiment. More specifically, FIG. 12 is a block diagram of a distance image sensor and a light source device as an example of the ranging device 30 described in the above embodiment.

As illustrated in FIG. 12, the distance image sensor 401 includes an optical system 402, a photoelectric conversion device 403, an image processing circuit 404, a monitor 405, and a memory 406. The distance image sensor 401 receives light (modulated light or pulsed light) emitted from a light source device 411 toward an object and reflected by the surface of the object. The distance image sensor 401 can acquire a distance image corresponding to a distance to the object based on a time period from light emission to light reception.

The optical system 402 includes one or a plurality of lenses, and guides image light (incident light) from the object to the photoelectric conversion device 403 to form an image on a light receiving surface (sensor portion) of the photoelectric conversion device 403.

As the photoelectric conversion device 403, the pulse generation circuit 33 and the processing circuit 34 of the above-described embodiments can be applied. The photoelectric conversion device 403 supplies a distance signal indicating a distance obtained from the received light signal to the image processing circuit 404.

The image processing circuit 404 performs image processing for forming a distance image based on the distance signal supplied from the photoelectric conversion device 403. The distance image (image data) obtained by the image processing can be displayed on the monitor 405 and stored (recorded) in the memory 406.

The distance image sensor 401 configured in this manner can acquire an accurate distance image by applying the configuration of the above-described embodiment.

### Sixth Embodiment

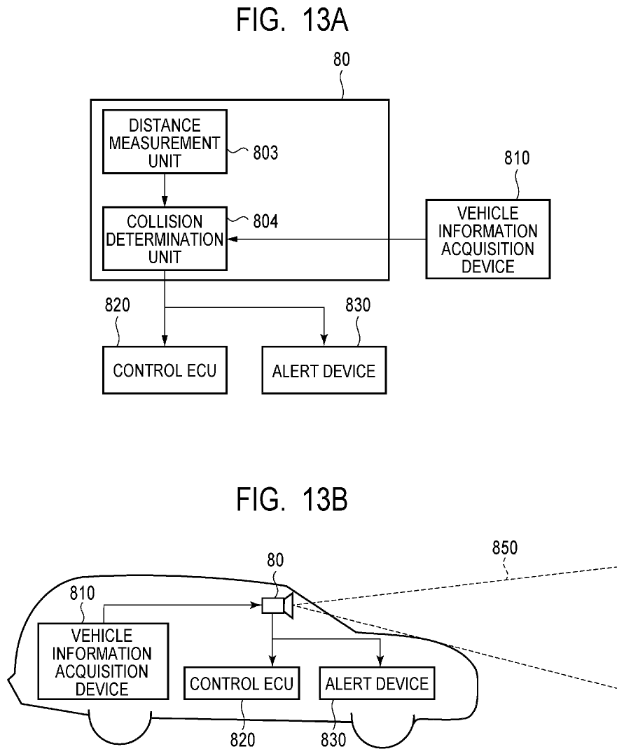

FIGS. 13A and 13B are block diagrams of equipment relating to an in-vehicle ranging device according to the present embodiment. Equipment 80 includes a distance measurement unit or circuit 803, which is an example of the ranging device of the above-described embodiments, and a signal processing device (processing device) that processes a signal from the distance measurement circuit 803. The equipment 80 includes the distance measurement circuit 803 that measures a distance to an object, and a collision determination unit or circuit 804 that determines whether or not there is a possibility of collision based on the measured distance. The distance measurement circuit 803 is an example of a distance information acquisition unit or circuit that obtains distance information to the object. That is, the distance information is information on a distance to the object or the like. The collision determination circuit 804 may determine the collision possibility using the distance information.

The equipment 80 is connected to a vehicle information acquisition device 810, and can obtain vehicle information such as a vehicle speed, a yaw rate, and a steering angle. Further, the equipment 80 is connected to a control ECU 820 which is a control device that outputs a control signal for generating a braking force to the vehicle based on the determination result of the collision determination circuit 804. The equipment 80 is also connected to an alert device 830 that issues an alert to the driver based on the determination result of the collision determination circuit 804. For example, when the collision possibility is high as the determination result of the collision determination circuit 804, the control ECU 820 performs vehicle control to avoid collision or reduce damage by braking, returning an accelerator, suppressing engine output, or the like. The alert device 830 alerts the user by sounding an alarm, displaying alert information on a screen of a car navigation system or the like, or giving vibration to a seat belt or a steering wheel. These devices of the equipment 80 function as a movable body control unit or circuit that controls the operation of controlling the vehicle as described above.

In the present embodiment, ranging is performed in an area around the vehicle, for example, a front area or a rear area, by the equipment 80. FIG. 13B illustrates equipment when ranging is performed in the front area of the vehicle (ranging area 850). The vehicle information acquisition device 810 as a ranging control unit or circuit sends an instruction to the equipment 80 or the distance measurement circuit 803 to perform the ranging operation. With such a configuration, the accuracy of distance measurement can be further improved.

Although the example of control for avoiding a collision to another vehicle has been described above, the embodiment is applicable to automatic driving control for following another vehicle, automatic driving control for not going out of a traffic lane, or the like. Furthermore, the equipment is not limited to a vehicle such as an automobile and can be applied to a movable body (movable apparatus) such as a ship, an airplane, a satellite, an industrial robot and a consumer use robot, or the like, for example. In addition, the equipment can be widely applied to equipment which utilizes object recognition or biometric authentication, such as an intelligent transportation system (ITS), a surveillance system, or the like without being limited to movable bodies.

### Modified Embodiments

The disclosure is not limited to the above embodiment, and various modifications are possible. For example, an example in which some of the configurations of any one of the embodiments are added to other embodiments and an example in which some of the configurations of any one of the embodiments are replaced with some of the configurations of other embodiments are also embodiments of the disclosure.

The disclosure of this specification includes a complementary set of the concepts described in this specification. That is, for example, if a description of “A is B” (A=B) is provided in this specification, this specification is intended to disclose or suggest that “A is not B” even if a description of “A is not B” (A B) is omitted. This is because it is assumed that “A is not B” is considered when “A is B” is described.

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-084360, filed May 24, 2022, which is hereby incorporated by reference herein in its entirety.

What is claimed is:

1. A ranging device comprising:
a time counting circuit configured to count time over a period including a plurality of count periods;
a pulse generation circuit configured to generate a signal including a pulse based on light including reflected light from an object;
a first holding circuit configured to sequentially perform an operation of holding a pulse count value based on the number of pulses in a corresponding count period for each of the plurality of count periods;
a second holding circuit configured to hold N sets (N being an integer equal to or greater than 1) of identification information indicating one of the plurality of count periods and a pulse count value corresponding to the identification information; and
a comparison circuit configured to compare the pulse count value held in the first holding circuit with the N pulse count values held in the second holding circuit and perform an update process of holding, in the second holding circuit, identification information that specifies each of count periods whose rank of magnitude of a pulse count value in descending order is up to the N-th, and a pulse count value corresponding to the identification information.

2. The ranging device according to claim 1 further comprising:
a light emitting circuit configured to emit light to the object; and
a control circuit configured to synchronously control a timing at which the light emitting circuit emits light and a timing at which the time counting circuit starts counting.

3. The ranging device according to claim 2 further comprising a third holding circuit configured to acquire and hold the identification information held in the second holding circuit each time the light emitting circuit emits light a predetermined number of times.

4. The ranging device according to claim 3, wherein when the third holding circuit acquires the identification information, the second holding circuit deletes the held information.

5. The ranging device according to claim 3 further comprising an output circuit configured to output information held in the third holding circuit to outside.

6. The ranging device according to claim 3, wherein the third holding circuit holds a distribution of frequencies for each of the plurality of count periods whose rank of magnitude of a pulse count value in descending order is up to the N-th.

7. The ranging device according to claim 3, wherein the third holding circuit holds the identification information indicating a count period whose rank of magnitude of a pulse count value in descending order is up to the N-th.

8. The ranging device according to claim 1, wherein the N is equal to 1.

9. The ranging device according to claim 1, wherein the N is equal to or greater than 2.

10. The ranging device according to claim 1 comprising a plurality of the pulse generation circuits arranged to form a plurality of rows and a plurality of columns,
wherein the first holding circuit, the second holding circuit, and the comparison circuit are arranged so as to correspond to each of the plurality of pulse generation circuits.

11. The ranging device according to claim 1 comprising a plurality of the pulse generation circuits arranged to form a plurality of rows and a plurality of columns,
wherein one first holding circuit is arranged to receive a signal including the pulse and coordinate information of the pulse generation circuit from the plurality of pulse generation circuits.

12. The ranging device according to claim 1,
wherein the pulse generation circuit includes a plurality of photoelectric conversion elements, and
wherein the first holding circuit holds a pulse count value in which pulses based on light incident on the plurality of photoelectric conversion elements are integrated.

13. The ranging device according to claim 1, wherein the comparison circuit performs the update process each time the first holding circuit holds the pulse count value.

14. The ranging device according to claim 1,
wherein the pulse generation circuit includes an avalanche photodiode, and
wherein the pulse indicates that a photon is incident on the avalanche photodiode.

15. The ranging device according to claim 1, wherein a distance from the ranging device to the object is calculated based on the identification information.

16. A photodetection system comprising:
the ranging device according to claim 1; and
a signal processing circuit configured to process a signal output from the ranging device.

17. A movable body comprising:
the ranging device according to claim 1; and
a movable body control circuit configured to control the movable body based on distance information acquired by the ranging device.
